(19) United States
(12) Patent Application Publication
(10) Pub. No.: US 2023/0232242 A1
(43) Pub. Date: Jul. 20, 2023

(54) IMPROVED SPECTRUM ANALYZER FOR WI-FI

(71) Applicant: MAXLINEAR, INC., Carlsbad, CA (US)

(72) Inventors: Saju Palayur, Poway, CA (US); Salvador Iranzo Molinero, Carlsbad, CA (US)

(21) Appl. No.: 18/064,191

(22) Filed: Dec. 9, 2022

Related U.S. Application Data
(60) Provisional application No. 63/266,938, filed on Jan. 19, 2022.
(60) Provisional application No. 63/366,236, filed on Jun. 10, 2022.

(51) Int. Cl. H04W 16/14; H04W 52/02; H04W 24/08

(52) U.S. Cl. CPC H04W 16/14; H04W 52/0206; H04W 24/08; H04W 84/12

(57) ABSTRACT

A method for collecting frequency spectrum data for an automated frequency coordination (AFC) system includes determining an operation mode of a Wi-Fi access point. The method also includes in response to a determination that the operation mode is associated with 6 GHz transmissions, determining a power mode of the Wi-Fi access point. The method also includes in response to a determination that the Wi-Fi access point is in a standard power mode, scanning one or more 6 GHz bands to begin collecting 6 GHz frequency spectrum data.

### CROSS REFERENCE TO RELATED APPLICATIONS

This U.S. patent application claims priority to Provisional Patent Application 63/266,938 filed on Jan. 19, 2022 and to U.S. Provisional Patent Application 63/366,236 filed on Jun. 10, 2022. The disclosure of this prior application is considered part of the disclosure of this application and is hereby incorporated by reference in its entirety.

### TECHNICAL FIELD

This disclosure relates to detecting Wi-Fi interference and also relates to a spectrum analyzer, and in particular, to a Wi-Fi access point (AP) based spectrum analyzer (e.g., Wi-Fi AP configured with a spectrum analyzer, Wi-Fi AP in association with a spectrum analyzer) for automated frequency coordination (AFC) system.

### BACKGROUND

Unless otherwise indicated herein, the materials described herein are not prior art to the claims in the present application and are not admitted to be prior art by inclusion in this section.

Institute of Electrical and Electronics Engineers (IEEE) 802.11 standards include protocols for implementing wireless local area network (WLAN) communications, including Wi-Fi. Wi-Fi communications are configured to occur in multiple frequency bands, including 2.4 GHz, 5 GHz, and 6 GHz bands. Some incumbent communication systems (e.g., existing communication systems operating in licensed bands) may also be configured to communicate using the same or similar frequencies as Wi-Fi communications. In some circumstances, interference between the Wi-Fi communications and the incumbent communications may occur.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

One aspect of the disclosure provides a method for collecting frequency spectrum data for an automated frequency coordination (AFC) server. The method includes determining, by one or more processors (of a Wi-Fi access point), an operation mode of the Wi-Fi access point. In response to a determination that the operation mode is associated with 6 GHz transmissions, the method includes determining, by the one or more processors, a power mode of the Wi-Fi access point. In response to a determination that the Wi-Fi access point is in a standard power mode, the method also includes scanning one or more 6 GHz bands to begin collecting 6 GHz frequency spectrum data.

Implementations of the disclosure may include one or more of the following optional features. In some implementations, in response to a determination that the operation mode is unassociated with the 6 GHz transmissions, the method includes determining, by the one or more processors, that the Wi-Fi access point operates in one or more non-6 GHz bands. In some implementations, in response to a determination that the Wi-Fi access point is in a non-standard power mode, the methods includes determining, by the one or more processors, that the Wi-Fi access point is a low power mode or a very low power mode. In some implementations, in response to a determination that the Wi-Fi access point is in the low power mode or the very low power mode, the method includes determining, by the one or more processors, not to start scanning the one or more 6 GHz bands. In some implementations, the one or more 6 GHz bands include one or more bands from unlicensed national information infrastructure (U-MI) bands. In some implementations, the U-NII bands include U-NII-5 band, U-NII-6 band, U-NII-7 band, and U-NII-8 band. Implementations may also include use of licensed bands, or a combination of licensed and unlicensed bands.

In some implementations, the method includes stitching, by the one or more processors, the collected 6 GHz frequency spectrum data together. In some implementations, stitching the collected 6 GHz frequency spectrum data together includes combining the collected 6 GHz frequency spectrum data associated with a same band. In some implementations, the method includes transmitting, by the one or more processors, a report based on the stitched 6 GHz frequency spectrum data to an AFC server. In some implementations, in response to a determination that the Wi-Fi access point is in the standard power mode, the method includes scanning 6 GHz Wi-Fi channels to begin collecting 6 GHz Wi-Fi frequency spectrum data. In some implementations, the method includes decoding, by the one or more processors, one or more Wi-Fi packets that are associated with the collected 6 GHz Wi-Fi frequency spectrum data. In some implementations, when the one or more Wi-Fi packets are decodable, the method includes generating a report of the 6 GHz Wi-Fi channels and transmitting the report to an AFC server. In some implementations, when the one or more Wi-Fi packets are un-decodable the method includes transmitting the collected 6 GHz Wi-Fi frequency spectrum data to the AFC server.

Another aspect of the disclosure provides a Wi-Fi access point for collecting frequency spectrum data for an AFC server, the Wi-Fi access point includes data processing hardware (e.g., one or more processors) and memory hardware in communication with the data processing hardware. The memory hardware stores instructions that when executed on the data processing hardware cause the data processing hardware to perform operations. The operations include determining an operation mode of the Wi-Fi access point. In response to a determination that the operation mode is associated with 6 GHz transmissions, the operations include determining a power mode of the Wi-Fi access point. In response to a determination that the Wi-Fi access point is in a standard power mode, the operations include scanning one or more 6 GHz bands to begin collecting 6 GHz frequency spectrum data.

Implementations of the disclosure may include one or more of the following optional features. In some implementations, in response to a determination that the operation mode is unassociated with the 6 GHz transmissions, the operations include determining that the Wi-Fi access point operates in one or more non-6 GHz bands. In some implementations, in response to a determination that the Wi-Fi access point is in a non-standard power mode, the operations include determining that the Wi-Fi access point is a low power mode or a very low power mode. In some implementations, in response to a determination that the Wi-Fi access point is in the low power mode or the very low power mode, the operations include determining not to start scanning the one or more 6 GHz bands. In some implementations, the one or more 6 GHz bands include one or more licensed bands, or bands from U-MI bands. In some implementations, the U-MI bands include U-NII-5 band, U-NII-6 band, U-NII-7 band, and U-NII-8 band.

In some implementations, the operations include stitching the collected 6 GHz frequency spectrum data together. In some implementations, stitching the collected 6 GHz frequency spectrum data together includes combining the collected 6 GHz frequency spectrum data associated with a same band. In some implementations, the operations include transmitting a report based on the stitched 6 GHz frequency spectrum data to an AFC server. In some implementations, in response to a determination that the Wi-Fi access point is in the standard power mode, the operations include scanning 6 GHz Wi-Fi channels to begin collecting 6 GHz Wi-Fi frequency spectrum data. In some implementations, the operations include decoding, by the one or more processors, one or more Wi-Fi packets that are associated with the collected 6 GHz Wi-Fi frequency spectrum data. In some implementations, when the one or more Wi-Fi packets are decodable, the operations include generating a report of the 6 GHz Wi-Fi channels and transmitting the report to an AFC server. In some implementations, when the one or more Wi-Fi packets are un-decodable the operations include transmitting the collected 6 GHz Wi-Fi frequency spectrum data to the AFC server.

### DESCRIPTION OF DRAWINGS

Example implementations will be described and explained with additional specificity and detail through the use of the accompanying drawings in which:

FIG. 1 illustrates an example computer modeling of service paths of microwave links (e.g., 6 GHz incumbent communication systems) in an example service area in accordance with some implementations of this disclosure.

FIG. 2 illustrates a block diagram of an example automated frequency coordination (AFC) system in accordance with some implementations of this disclosure;

FIG. 3A illustrates an example Wi-Fi access point (AP)-based spectrum analyzer for an AFC server in accordance with some implementations of this disclosure;

FIG. 3B illustrates a first backhaul device, a first interference estimator associated with the first backhaul device (e.g., first backhaul device including the first interference estimator), a second backhaul device, and a second interference estimator associated with the second backhaul device (e.g., second backhaul device including the second interference estimator) in accordance with some implementations of this disclosure.

FIG. 4 illustrates an example Wi-Fi AP-based spectrum analyzer for an AFC server in accordance with some implementations of this disclosure;

FIG. 5 illustrates an example Wi-Fi AP-based spectrum analyzer for an AFC server in accordance with some implementations of this disclosure;

FIG. 6A illustrates a flowchart of an example method to obtain frequency spectrum data by a Wi-Fi AP-based spectrum analyzer for an AFC server in accordance with some implementations of this disclosure;

FIG. 6B illustrates a flowchart of an example method to determine or estimate interference in accordance with some implementations of the this disclosure; and

FIG. 7 illustrates an example computing system that may be used for a Wi-Fi AP-based spectrum analyzer for an AFC server in accordance with some implementations of this disclosure.

Like reference symbols in the various drawings indicate like elements.

### DETAILED DESCRIPTION

In association with 6 GHz Wi-Fi communications, the Federal Communications Commission (FCC) requires that predicted interference-to-noise (I/N) ratios at any existing 6 GHz receivers (e.g., incumbent systems or users such as users licensed to operate in 6 GHz frequency band) are to not exceed −6 dB (or a predetermined dB). In some circumstances, an access point (AP) seeking deployment may demonstrate or validate that communications in the 6 GHz frequency band are not exceed the −6 dB I/N ratio through a lab testing and/or a field testing. In some circumstances, without the −6 dB UN ratio validation, the AP can only be operated in a low power indoor (LPI) mode (e.g., AP using 18 dBm in 20 MHz channel width).

The FCC has issued a mandate that 6 GHz access points (AP) obtain authorization from an automated frequency coordination (AFC) system (e.g., AFC system (server) in the region) before operating in a standard power mode (e.g., mode that generates a maximum transmission power of 36 dBm). In some circumstances, an AFC database may be configured to store devices and/or associated frequencies configured to communicate in the 6 GHz frequencies. For example, the FCC may request and/or require incumbent 6 GHz users to register their devices in an AFC database. In some implementations, the AFC database is based on FCC database (6 GHz incumbent device registration database), universal licensing system (ULS) database, and/or equipment authorization system (EAS) database.

An AP configured to transmit 6 GHz frequencies (also referred as 6 GHz AP or 6 GHz Wi-Fi AP) is configured to access the AFC database. The 6 GHz AP may be configured to determine frequencies in the AFC database relative to the frequencies of operation of the 6 GHz AP. In instances in which a 6 GHz AP fails to access and/or compare operational frequencies to the registered frequencies in the AFC database, the 6 GHz AP may be limited to communications in a low power mode (e.g., low power indoor (LPI) mode).

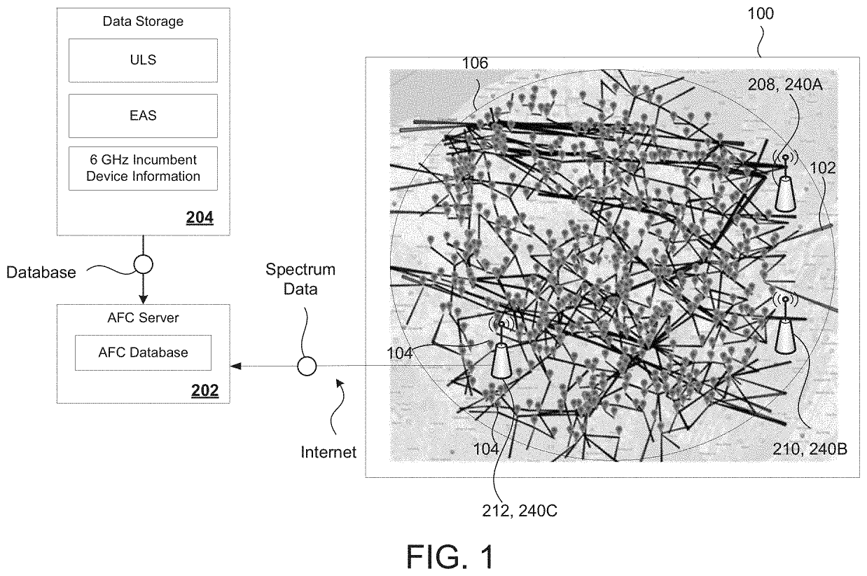

FIG. 1 illustrates an example computer modeling 100 of service paths 102 of microwave links between incumbent systems 104 (e.g., 6 GHz incumbent communication systems) in an example service area 106 that the computer modeling 100 can be improved using frequency spectrum data provided by access points (APs) (standalone AP 212 in this example).

In some implementations, an AFC system (AFC server 202 in this example) is configured to determine distances between a location of an AP requesting to operate in a standard power mode (standalone AP 212 in this example) and microwave receivers (e.g., incumbent systems 104) located nearby the requesting AP based on the AFC database (e.g., database including or associating with the incumbent device registration database, ULS database, and/or EAS database) and is configured to evaluate the potential interference the requesting AP might cause to the microwave receivers based on the determined distances and/or a computer modeling such as the example computer modeling 100 shown in FIG. 1. Based on the result (e.g., predicted interference-to-noise ratio not exceed −6 dB at the microwave receivers), the AFC system authorizes the requesting AP (standalone AP 212 in this example) to operate in the standard power mode (e.g., planned frequencies/power the requesting AP requesting to use). However, implementations of using computer modeling 100 and distances between a 6 GHz AP (standalone AP 212 in this example) and microwave receivers (incumbent systems 104 in this example) nearby as discussed above have shortcomings since the implementations lacks an accurate mechanism to measure the ground reality. As shown, in some implementations, the requesting AP (standalone AP 212 in this example) includes or associated with a spectrum analyzer 240C to collect frequency spectrum data including 6 GHz transmissions between incumbent systems 104. In some implementations, the frequency spectrum data includes location of incumbent systems 104. With additional spectrum information provided by the 6 GHz AP (standalone AP 212 in this example) in the field, the AFC system can make a more accurate informed decision.

In some implementations, the 6 GHz AP may be configured to determine a distance between the 6 GHz AP and the microwave receivers (e.g., incumbent systems) located nearby. The 6 GHz AP may be configured to determine a potential interference between transmissions from the 6 GHz AP and one or more incumbent systems and may determine whether to transmit or to operate in a standard power mode (e.g., 36 dBm transmission), a low power mode (e.g., 30 dBm transmission), a very low power mode (e.g., 14 dBm transmission), and/or a non-transmit mode.

Aspects of the present disclosure address these and other shortcomings of 6 GHz communications by including a spectrum analyzer as discussed above that may be configured to operate as a Wi-Fi AP based spectrum analyzer for AFC system. The spectrum analyzer may be configured to compare 6 GHz communications between an AP and incumbent 6 GHz systems registered in an AFC database.

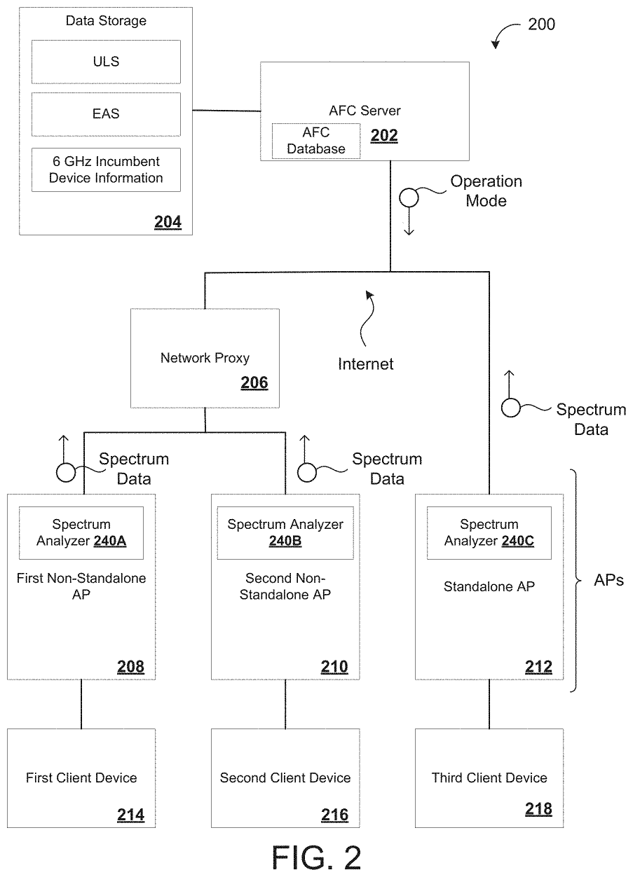

FIG. 2 illustrates a block diagram of an example AFC system 200 in accordance with some implementations of the present disclosure. In some implementations, the AFC system 200 includes an AFC server 202 and a data storage 204 (e.g., internal data storage, external data storage) in communication with the AFC server 202. In some implementations, the AFC system 200 also includes a network proxy 206, a first non-standalone AP 208, a second non-standalone AP 210, a standalone AP 212 (referred to collectively as the APs), a first client device 214 in communication with the first non-standalone AP 208, a second client device 216 in communication with the second non-standalone AP 210, and a third client device 218 in communication with standalone AP 212.

In some implementations, the data storage 204 includes one or more regulatory databases (e.g., universal licensing system (ULS) database, equipment authorization system (EAS) database). In some implementations, the data storage 204 includes at least incumbent systems and/or incumbent devices that may be configured to transmit using 6 GHz communications. For example, the universal licensing system (ULS) database may include a collection of licenses issued for communications using 6 GHz communications, such as a list of microwave links configured to transmit using a frequency between 5925 MHz and 7125 MHz (e.g., UNII-5 band through UNII-8 band). In some implementations, the data storage 204 is managed by a regulatory agency, such as the Federal Communications Commission (FCC). In other words, the data storage 204 can be an external data storage in communication with the AFC server 202.

In some implementations, the AFC server 202 is configured to obtain at least a portion of data from the data storage 204. For example, the AFC server 202 may be configured to obtain microwave links, such as from incumbent systems and/or incumbent devices, within a geographic area. Alternatively, or additionally, in some implementations, the AFC server 202 is configured to receive operational characteristics from an AP and/or a proxy, such as the standalone AP 212 and/or the network proxy 206, respectively. The operational characteristics may include a geolocation, a location confidence, an antenna height, an FCC ID, a serial number, and/or other device characteristics.

In some implementations, the AFC server 202 is configured to determine a predicted interference-to-noise (I/N) ratio on an incumbent system based on received operational characteristics. AFC server 202 may use one or more models (e.g., computer modeling) to determine the predicted I/N ratio for an incumbent system based on a 6 GHz AP requesting to operate in a standard power mode. Example models may include a free space model, a WINNER II model, an Irregular Terrain Model, and/or other suitable models. Alternatively, or additionally, in some implementations, the AFC server 202 is configured to use a spectrum analysis (e.g., frequency spectrum data) that may be provided by an AP (e.g., standalone AP 212) and/or a proxy (e.g., network proxy 206), that may be obtained from observed 6 GHz communications received by the AP or APs (e.g., first non-standalone AP 208, second non-standalone AP 210) associated with the proxy (e.g., network proxy 206), as described herein.

In some implementations, the AFC server 202 is configured to provide one or more usable frequencies to a 6 GHz AP (e.g., Wi-Fi AP), which frequencies may not cause an I/N ratio greater than −6 dB. For example, the AFC server 202 may determine that a first 6 GHz frequency may cause an I/N ratio of less than a threshold (e.g., less than −6 dB) at an incumbent system, and the AFC server 202 may provide the first 6 GHz frequency for use by the 6 GHz AP.

In some implementations, the APs (e.g., first non-standalone AP 208, second non-standalone AP 210, standalone AP 212) are Wi-Fi access points. In some implementations, the APs are configured to provide at least 6 GHz Wi-Fi to devices that may be communicatively coupled to the APs . In some implementations, as shown, each of the APs includes a spectrum analyzer 240A, 240B, 204C (referred to collectively as the spectrum analyzers 240) that may be configured to receive 6 GHz communications. For example, a spectrum analyzers 240 disposed in the APs may be configured to obtain 6 GHz communications from incumbent systems. In some implementations, the AFC system 200 includes one or more APs configured with a spectrum analyzer 240 that may be configured to receive 6 GHz communications. In some implementations, as shown, the standalone AP 212 is configured to provide frequency spectrum data (e.g., spectrum analyzer data) to the AFC server 202. Alternatively, or additionally, in some implementations, the first non-standalone AP 208 and the second non-standalone AP 210 are configured to communicate the frequency spectrum data to the network proxy 206, and the network proxy 206 is configured to provide the frequency spectrum data to the AFC server 202. In some implementations, the frequency spectrum data is communicated via a network such as the Internet. In some implementations, the AFC server 202 uses the provided frequency spectrum data in subsequent determinations, such as an I/N ratio associated with incumbent systems. In some implementations, the AFC server 202 uses the provided frequency spectrum data in subsequent determinations, such as an I/N ratio associated with incumbent systems along with other information (e.g., computer modeling, ULS, EAS, 6 GHz incumbent device information).

Modifications, additions, or omissions may be made to the AFC system 200 without departing from the scope of the present disclosure. For example, in some implementations, the AFC system 200 may include any number of other components that may not be explicitly illustrated or described.

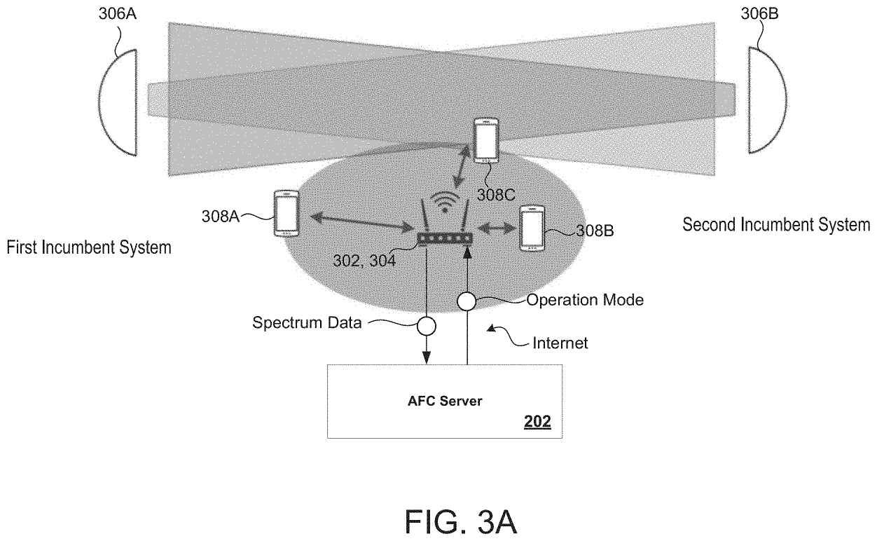

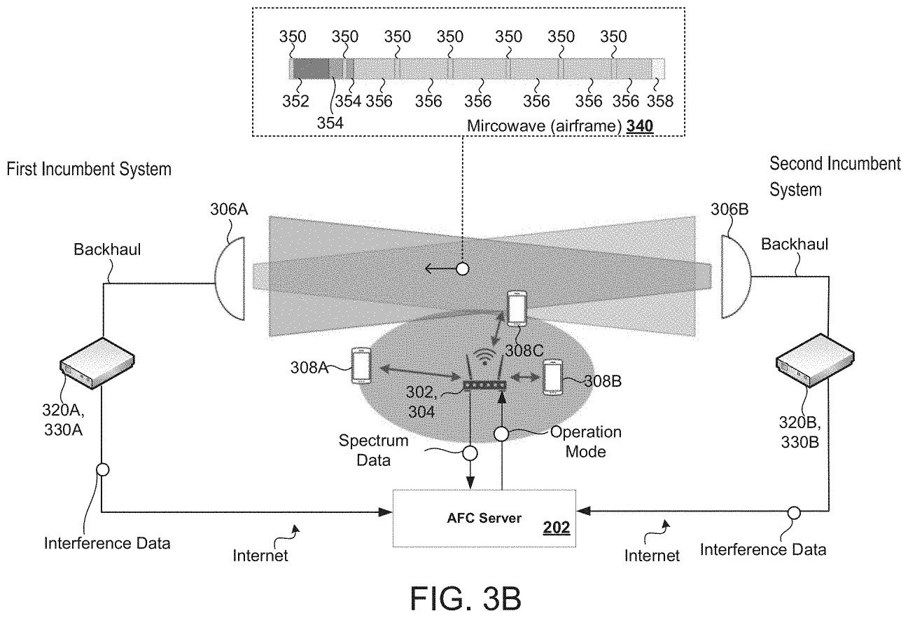

FIG. 3A illustrates an example Wi-Fi access point 302 (e.g., 6 GHz Wi-Fi AP) and a spectrum analyzer 304 associated with the Wi-Fi access point 302 for the AFC server 202 in accordance with some implementations of the present disclosure.

In some implementations, as shown, the Wi-Fi AP 302 is located in a microwave path between a first transceiver 306A and a second transceiver 306B. In some implementations, the Wi-Fi AP 302 is configured to broadcast communications, such as 6 GHz communications to one or more devices 308 (e.g., first device 308A, second device 308B, third device 308C shown in FIG. 3A) that are communicatively coupled to the Wi-Fi AP 302.

In some implementations, two transceivers 306A, 306B are configured to send and/or receive transmissions, which include 6 GHz communications. In some circumstances, a Wi-Fi AP 302 is configured to broadcast 6 GHz communications and disposed between and/or near a communication channel between the transceivers 306A, 306B cause interference in the 6 GHz communication channel.

In some implementations, as shown, the Wi-Fi AP 302 includes a spectrum analyzer 304. The spectrum analyzer 304 may be configured to detect and/or receive transmissions from incumbent systems (e.g., transceivers 306A, 306B in this example). For example, as illustrated, the spectrum analyzer 304 associated with the Wi-Fi AP 302 may be configured to obtain communications between two transceivers 306A, 306B.

In some implementations, the Wi-Fi AP 302 is configured to communicate with an AFC server 202. For example, the Wi-Fi AP 302 may be configured to transmit the obtained frequency spectrum data to the AFC server 202. In another example, the Wi-Fi AP 302 may be configured to receive transmissions from the AFC server 202. In some implementations, the AFC server 202 is configured to set an operation mode for the Wi-Fi AP 302. For example, the AFC server 202 may determine that transmission by the Wi-Fi AP 302 in a standard power mode may cause an I/N ratio at an incumbent system (transceivers 306A, 306B in this example) to be greater than a threshold (e.g., −6 dB I/N ratio) and the AFC server 202 may direct the Wi-Fi AP 302 to broadcast in a low power (indoor) mode or move to another frequency that does not overlap with the incumbent system. In some implementations, the frequency spectrum data transmitted to the AFC server 202 from the Wi-Fi AP 302 contributes that the AFC server 202 can make an accurate determination of an I/N ratio associated with incumbent systems (transceivers 306A, 306B in this example). For example, the AFC server 202 may be configured to use modeled transmissions and received frequency spectrum data from a Wi-Fi AP (or Wi-Fi APs) to make a determination of an I/N ratio associated with one or more incumbent systems.

Modifications, additions, or omissions may be made to the Wi-Fi access point 302 and the spectrum analyzer 304 associated with the Wi-Fi access point 302 without departing from the scope of the present disclosure. For example, in some implementations, the Wi-Fi access point 302 and the spectrum analyzer 304 may include any number of other components that may not be explicitly illustrated or described.

FIG. 3B illustrates a first backhaul device 320A (e.g., backhaul modem, microwave modem, microwave receiver), a first interference estimator 330A associated with the first backhaul device 320A, a second backhaul device 320B (e.g., backhaul modem, microwave modem, microwave receiver), and a second interference estimator 330B associated with the second backhaul device 320B in accordance with some implementations of this disclosure.

As discussed, in some implementations, the Wi-Fi AP 302 is located in the microwave path between the first transceiver 306A and the second transceiver 306B. As discussed, in some implementations, the Wi-Fi AP 302 is configured to broadcast communications, such as 6 GHz communications to one or more devices 308 (e.g., first device 308A, second device 308B, third device 308C shown in FIG. 3B) that are communicatively coupled to the Wi-Fi AP 302.

As shown, in some implementations, a first incumbent system includes a first transceiver 306A that is in communication with the first backhaul device 320A, and a second incumbent system includes a second transceiver 306B that is in communication with the second backhaul device 320B. For example, when the first incumbent system receives microwave from the second incumbent system, signals generated from the microwave is transmitted to the first backhaul device 320A. Likewise, when the second incumbent system receives microwave from the first incumbent system, signals generated from the microwave are transmitted to the second backhaul device 320B. As shown, in some implementations, each of the backhaul devices 320A, 320B is in communication with the AFC server 202. For example, the backhaul devices 320A, 320B are in communication with the AFC server 202 via a network such as the Internet.

As shown, in some implementations, the first interference estimator 330A is configured to determine and/or estimate interference in the microwave transmitted from the second incumbent system. Likewise, in some implementations, the second interference estimator 330B is configured to determine and/or estimate interference in the microwave transmitted from the first incumbent system. Determining or estimating the interference may be based on, or may include, distortion, interferences, noise, pilot symbols, among other data. The interference estimators 330A, 330B may use data related to a particular receiver, to a network, to an AP to determine interference and/or mean-square error (MSE) values.

In some implementations, the first interference estimator 330A is configured to detect and/or measure interference (including interference caused by the WI-FI AP 302 in this example). In some implementations, the first interference estimator 330A can use noise measurement on one or more pilot symbols 350 in the signals generated from microwave 340 received from the second incumbent system. As shown, in some implementations, the microwave 340 includes preamble symbols 352, adaptive coding modulation and bandwidth (ACMB) symbols 354, payload symbols 356, dummy symbols 358, and pilot symbols 350. As shown, in some implementations, the pilot symbols 350 include known symbols inserted periodically (e.g., one every 20 to 40 data symbols). In some implementations, the pilot spacing is configurable.

In some implementations, the first interference estimator 330A is configured to compare pilot symbols 350 received from the second incumbent system via the first incumbent system with the known symbols. The interference estimator 330A is configured to determine noise, interference, and/or mean-square error (MSE) based on the comparison. Since the pilot symbols 350 are known by the interference estimator 330A, noise, interference, and/or mean-square error (MSE) can be estimated more accurately by using pilot symbols than by using data symbols. For example, when the mean-square error (MSE) is high, it may indicate that there is a noise/interference issue with the communication. In some embodiments, the first interference estimator 330A may determine an interference based on using a noise measurement on one or more pilot symbols. In some embodiments, determining the interference based on using the noise measurement on the one or more pilot symbols may include performing a time analysis on one or more interferences locations.

In some implementations, based the determined noise, interference, and/or mean-square error (MSE), time varying noise floor can be detected.

In some implementations, the interference estimator 330A (of the first backhaul 320A) transmits the interference data (e.g., noise, interference value, MSE value) to the AFC server 202.

In some implementations, the AFC server 202 is configured to compare the interference data (e.g., noise, interference value, MSE value) received before and after the Wi-Fi AP 302 is in a standard power mode and use the comparison data to improve computer modeling. In other words, based on the interference data, accurate data can be provided to the AFC server 202 that indicates how much interference is caused by the Wi-Fi AP 302 (at the first incumbent system).

In some implementations, the second backhaul device 320B and the second interference estimator 330B operate similar to the first backhaul device 320A and the first interference estimator 330A.

In some implementations, the AFC server 202 uses the provided interference data in subsequent determinations, such as an IN ratio associated with incumbent systems along with other information (e.g., frequency spectrum data discussed in FIG. 3A, computer modeling, ULS, EAS, 6 GHz incumbent device information).

Modifications, additions, or omissions may be made to the backhaul device 320 and the interference estimator 330 associated with the backhaul device 320 without departing from the scope of the present disclosure. For example, in some implementations, the backhaul device 320 and the interference estimator 330 may include any number of other components that may not be explicitly illustrated or described.

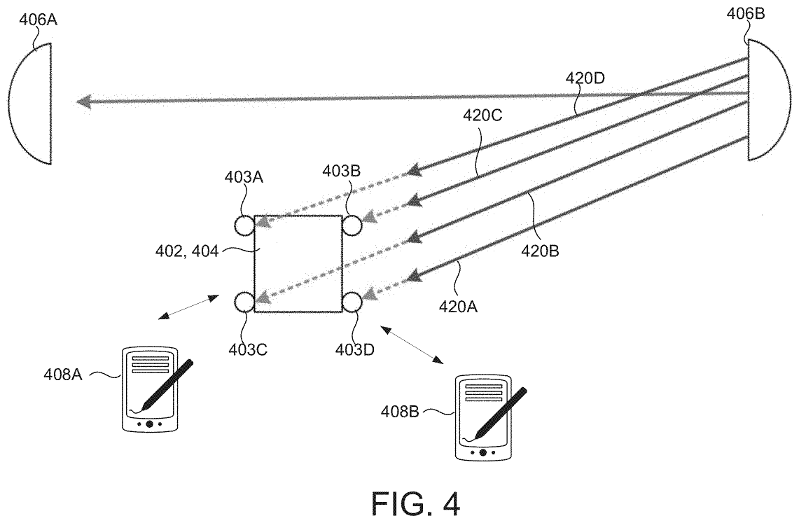

FIG. 4 illustrates an example Wi-Fi AP 402 and a spectrum analyzer 404 associated with the Wi-Fi AP 402 for the AFC server 202 in accordance with some implementations of the present disclosure.

In some implementations, the Wi-Fi AP 402 includes multiple antennas 403A, 403B, 403C, 403D (referred collectively as multiple antennas 403) that are configured to transmit and/or receive communications. For example, the multiple antennas 403 may be configured to broadcast communications, such as 6 GHz transmissions, to communicatively coupled devices 408A, 408B. In another example, the multiple antennas 403 may be configured to receive transmissions from a first incumbent system 406A and a second incumbent system 406B, such as 6 GHz communications from the second incumbent system 406B (e.g., microwave transmitter) as shown in FIG. 4.

In some implementations, the received signals 420 from the incumbent systems (signals 420A, 420B, 420C, 420D in this example) are used by the spectrum analyzer 404 associated with the Wi-Fi AP 402 to determine an approximate location of the incumbent system transmitter (incumbent system 406B in this example).

Alternatively, or additionally, in some implementations, the spectrum analyzer 404 is configured to determinate an approximate location of the incumbent system receiver (incumbent system 406A in this example), which may be paired with the incumbent system transmitter (incumbent system 406B in this example). In some implementations, the spectrum analyzer 404 is configured to determine the approximate location of incumbent system based on an angle of arrival of a transmission obtained from the incumbent system. For example, as shown, the spectrum analyzer 404 may be configured to obtain an angle of arrival for transmissions received at each antenna of the multiple antennas 403 of the Wi-Fi AP 402 and make a determination of the approximate location or position of the incumbent system (e.g., incumbent system 406A, incumbent system 406B). The radio signal's angle of arrival may be the direction from which the wave was received relative to the position of the Wi-Fi AP 402. The angle of arrival can be measured using multiple antennas receiving the same wave and correlating with the time stamp of the signal received on each antenna. In some implementations, the Wi-Fi APs support multiple-input and multiple-output (MIMO) to beamform radio waves to clients (stations) and may have hardware to measure one or more signals received from one or more fixed wireless microwave links.

In some implementations, the spectrum analyzer 404 is configured to determine and/or transmit the location of the incumbent systems (incumbent systems 406A, 406B in this example) to the AFC server 202 via a network such as the Internet.

In some implementations, the multiple antennas 403 are distributed about the Wi-Fi AP 402. For example, the multiple antennas 403 may be uniformly distributed around an exterior portion of the Wi-Fi AP 402. Alternatively, or additionally, in some implementations, the multiple antennas 403 are randomly distributed about the Wi-Fi AP 402, including the exterior portion or an interior portion. In some implementations, the spectrum analyzer 404 may be configured to use the distribution and/or orientation of the multiple antennas 403 to determine an approximate location of an incumbent system (e.g., incumbent systems 406A, 406B).

Modifications, additions, or omissions may be made to the Wi-Fi access point 402 and the spectrum analyzer 404 associated with the Wi-Fi access point 402 without departing from the scope of the present disclosure. For example, in some implementations, the Wi-Fi access point 402 and the spectrum analyzer 404 may include any number of other components that may not be explicitly illustrated or described.

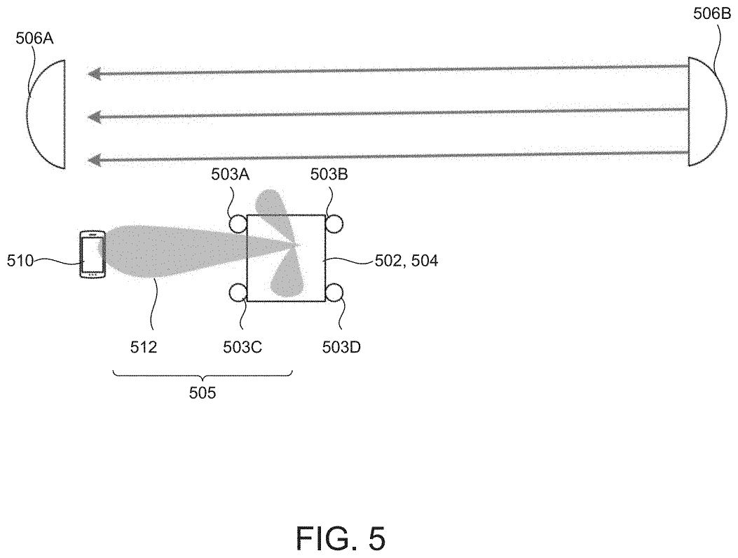

FIG. 5 illustrates an example Wi-Fi AP 502 and a spectrum analyzer 504 associated with the Wi-Fi AP 502 for the AFC system 200 in accordance with some implementations of the present disclosure.

In some implementations, the Wi-Fi AP 502 is configured to generate an antenna radiation pattern 505 that may reduce potential interference with incumbent communications (communications between a first incumbent system 506A and a second incumbent system 506B in this example). In some implementations, the spectrum analyzer 504 associated with the Wi-Fi AP 502 determines an approximate location of an incumbent transmitter system (second incumbent system 506B in this example) and/or an incumbent receiver system (first incumbent system 506A in this example) and/or an associated channel between the incumbent transmitter system (second incumbent system 506B in this example) and the incumbent receiver system (first incumbent system 506A in this example). In some implementations, the Wi-Fi AP 502 is configured to generate the antenna radiation pattern 505 based on the determinations relative to the incumbent systems (first incumbent system 506A and second incumbent system 506B in this example).

For example, as illustrated in FIG. 5, a communication channel between an incumbent transmitter system (second incumbent system 506B in this example) and an incumbent receiver system (first incumbent system 506A in this example) may be established and/or determined by the Wi-Fi AP 502, such as by a spectrum analyzer 504. As shown, the Wi-Fi AP 502 may be configured to generate an antenna radiation pattern 505 for communications with a communicatively coupled device 510 that may reduce and/or limit an amount of interference with the incumbent systems 506A, 506B. For example, the antenna radiation pattern 505 may include a main lobe 512 that may be arranged to reduce interference with the communications between the incumbent systems 506A, 506B. A transmission may be robust in the direction of the main lobe 512 and may be weak in side lobe directions. Transmission, for example, may be close to zero in the areas between the main lobe and side lobe and between separate side lobes. This may be referred to as an antenna null. In beamforming, various antennas in an array may be given a same signal with phase shifts or delays to form the beam in a desired direction. This electronically steered antenna array includes the main lobe, side lobes, and nulls. A null can be created in the order of the path of the microwave beam to have less interference in that path.

Modifications, additions, or omissions may be made to the Wi-Fi access point 502 and the spectrum analyzer 504 associated with Wi-Fi access point 502 without departing from the scope of the present disclosure. For example, in some implementations, the Wi-Fi access point 402 and the spectrum analyzer 404 may include any number of other components that may not be explicitly illustrated or described.

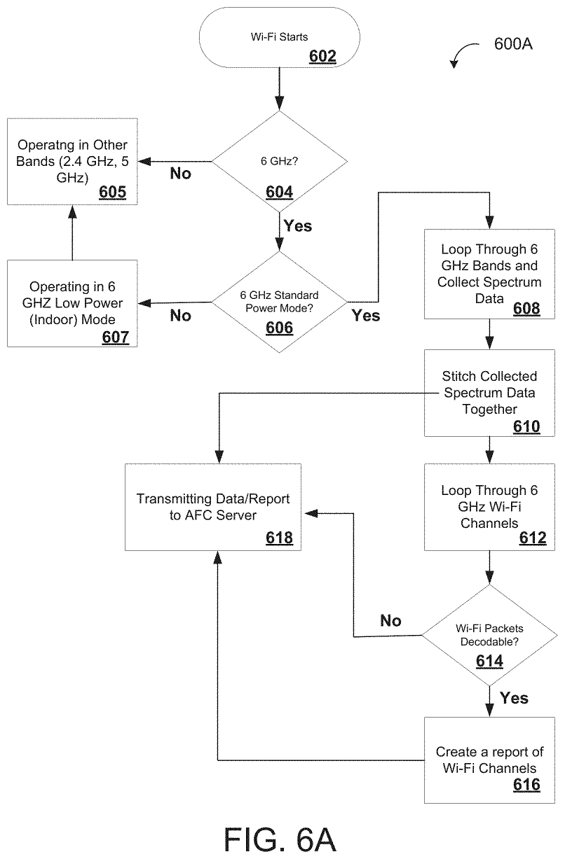

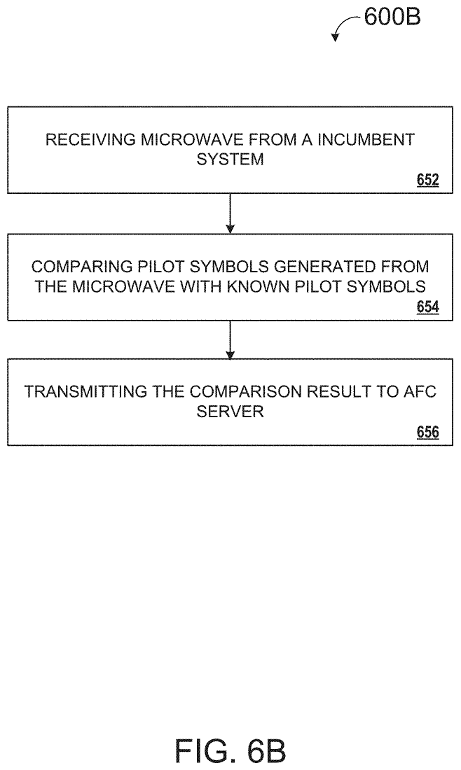

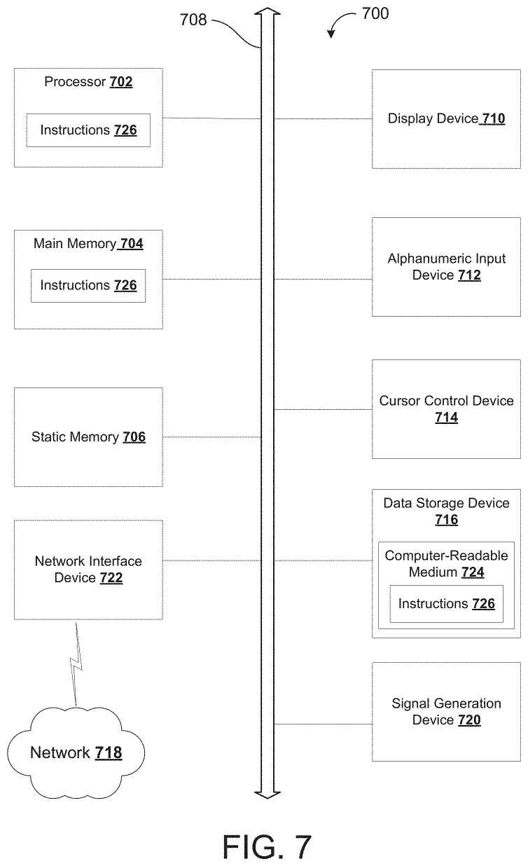

FIG. 6A illustrates a flowchart of an example method 600A to obtain frequency spectrum data by a spectrum analyzer (e.g., spectrum analyzer 240C in FIG. 2) associated with a Wi-Fi AP (e.g., standalone AP 212 in FIG. 2) for the AFC server (e.g., AFC server 202 in FIG. 2) in accordance with some implementations of the present disclosure. The method 600A may be performed by processing logic that may include hardware (circuitry, dedicated logic, processor(s), etc.), software (such as is run on a general purpose computer system or a dedicated machine), or a combination of both, which processing logic may be included in any computer system (e.g., computer device 700 in FIG. 7) or device. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 600A, at operation 602, may begin where the Wi-Fi AP (e.g., standalone AP 212 in FIG. 2) begins operation. In some implementations, processing logic associated with the Wi-Fi AP may perform an initialization and/or calibration to the Wi-Fi AP. For example, the processing logic may determine the functionality of one or more antennas associated with the Wi-Fi AP and may calibrate the one or more antennas. In instances in which the function of the one or more antennas exceeds a threshold performance level, the processing logic may determine to calibrate the antennas.

The method 600A, at operation 604, includes determining an operation mode of the Wi-Fi AP. For example, the processing logic may determine whether the Wi-Fi AP is in an operation mode including 6 GHz transmissions. The operation mode of the Wi-Fi AP may also be used for any frequency, including for other frequencies that the FCC or other entities may approve.

As shown, in instances in which the Wi-Fi AP is not using 6 GHz transmissions, the method 600A, at operation 605, includes determining that the Wi-Fi AP is operating in other bands (e.g., 5 GHz and/or 2.4 GHz). The method 600A may include determining to not collect frequency spectrum data. For example, the processing logic may determine that the Wi-Fi AP is operating in other bands (e.g., 5 GHz and/or 2.4 GHz) and may determine to not collect frequency spectrum data.

As shown, in instances in which the Wi-Fi AP is using 6 GHz transmissions, the method 600A, at operation 606, includes determining an operational mode (e.g., standard power mode (e.g., 36 dBm transmission), low power mode (30 dBm transmission), or very low power mode (14 dBm transmission) of the Wi-Fi AP 6 GHz transmissions. For example, the processing logic may determine an operational mode of the Wi-Fi AP 6 GHz transmissions.

In instances in which the Wi-Fi AP is not in a standard power mode, the method 600A, at operation 607, includes determining that the Wi-Fi AP is transmitting 6 GHz transmissions in either low power mode or very low power mode. For example, the processing logic may determine that the Wi-Fi AP is transmitting 6 GHz transmissions in either low power mode or very low power mode. Alternatively, or additionally, the processing logic may determine to not collect frequency spectrum data.

In instances in which the Wi-Fi AP is in the standard power mode (using 6 GHz transmissions), the method 600A, at operation 608, includes looping (e.g., scanning) through one or more 6 GHz bands to begin collecting frequency spectrum data. For example, the processing logic may be configured to loop through one or more 6 GHz bands to begin collecting frequency spectrum data. In some implementations, the processing logic is configured to scan the UNII-5 band, the UNII-6 band, the UNII-7 band, and/or the UNII-8 band and collect frequency spectrum data based on the results of the scans.

In some implementations, the method 600A, at operation 610, includes stitching the collected frequency spectrum data together. For example, the processing logic may be configured to stitch the collected frequency spectrum data together. The processing logic may be configured to combine the collected frequency spectrum data from each band that was scanned. In some implementations, the method 600A, at operation 618, includes transmitting the stitched frequency spectrum data to an AFC server (e.g., AFC server 202 in FIG. 2), where the AFC server may be configured to use the stitched frequency spectrum data in determining I/N ratios associated with incumbent systems and 6 GHz standard power Wi-Fi APs.

In some implementations, the method 600A, at operation 612, includes looping (scanning) through 6 GHz Wi-Fi channels to begin collecting frequency spectrum data associated with 6 GHz Wi-Fi. For example, the processing logic may be configured to loop through 6 GHz Wi-Fi channels to begin collecting frequency spectrum data associated with 6 GHz Wi-Fi. In some implementations, the method 600A, at operation 614, includes decoding of the collected GHz Wi-Fi frequency spectrum data. For example, the processing logic may be configured to attempt decoding of collected 6 GHz Wi-Fi frequency spectrum data.

In instances in which the processing logic in unable to determine one or more Wi-Fi packets associated with the 6 GHz Wi-Fi frequency spectrum data, the method 600A, at operation 618, includes transmitting the obtained 6 GHz Wi-Fi frequency spectrum data to the AFC server. For example, the processing logic may be configured to transmit the obtained 6 GHz Wi-Fi frequency spectrum data to the AFC server.

In instances in which the processing logic is able to determine one or more Wi-Fi packets associated with the 6 GHz Wi-Fi frequency spectrum data, the method 600A, at operation 616, includes generating a report of the one or more 6 GHz Wi-Fi channels associated with the collected Wi-Fi packets. For example, the processing logic may generate a report of the one or more 6 GHz Wi-Fi channels associated with the collected Wi-Fi packets. In some implementations, the method 600A, at operation 618, includes transmitting the generated a 6 GHz Wi-Fi report to the AFC server. For example, the processing logic may be configured to transmit the generated 6 GHz Wi-Fi report to the AFC server. In these and other implementations, the AFC server may be configured to use stitched frequency spectrum data, the obtained 6 GHz Wi-Fi frequency spectrum data, and/or the generated 6 GHz Wi-Fi report in determining I/N ratios associated with incumbent systems and 6 GHz standard power Wi-Fi access point (APs).

In some implementations, the location of incumbent systems (e.g., incumbent system receiver, incumbent system transmitter) may be determined by the spectrum analyzer and transmitted from the Wi-Fi AP to the AFC server. In some implementations, incumbent systems information is included in the frequency spectrum data. In some implementations, the AFC server may be configured to use the incumbent system location(s) determined by the AP, the stitched frequency spectrum data, the obtained 6 GHz Wi-Fi frequency spectrum data, and/or the generated 6 GHz Wi-Fi report in determining I/N ratios associated with incumbent systems and 6 GHz standard power Wi-Fi access point (APs).

Modifications, additions, or omissions may be made to the method to obtain frequency spectrum data for the AFC server without departing from the scope of the present disclosure. For example, in some embodiments, the method may include any number of other components that may not be explicitly illustrated or described.

FIG. 6B illustrates a flowchart of an example method 600B to determine or estimate interference in accordance with some implementations of this disclosure. The method 600B may be performed by processing logic that may include hardware (circuitry, dedicated logic, processor(s), etc.), software (such as is run on a general purpose computer system or a dedicated machine), or a combination of both, which processing logic may be included in any computing system (e.g., computer device in FIG. 7). For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 600B, at operation 652, includes receiving a microwave signal from a system (e.g., second incumbent system in FIG. 3B). As discussed, in some implementations, known pilot symbols 350 are periodically inserted in signals generated by the microwave incumbent.

The method 600B, at operation 654, includes comparing pilot symbols generated from the microwave with known pilot symbols. In some implementations, based on the comparison, a mean-square error (MSE) value is determined by the interference estimator (e.g., first interference estimator 330A in FIG. 3B). In some implementations, based on the comparison, a noise value is determined by the interference estimator (e.g., first interference estimator 330A in FIG. 3B). In some implementations, based on the comparison, an interference value is determined by the interference estimator (e.g., first interference estimator 330A in FIG. 3B). The method 600B, at operation 656, includes transmitting the comparison result to the AFC server 202. In some implementations, the AFC server 202 is configured to compare the data (e.g., noise value, interference value, MSE value) received before and after the Wi-Fi AP 302 is in a standard power mode and use the comparison data to improve computer modeling.

FIG. 7 is a schematic view illustrating a machine in the example form of a computing device 700 within which a set of instructions, for causing the machine to perform any one or more of the methods discussed herein, may be executed. The computing device 700 may include a mobile phone, a smart phone, a netbook computer, a rackmount server, a router computer, a server computer, a personal computer, a mainframe computer, a laptop computer, a tablet computer, a desktop computer, an access point (spectrum analyzer), a backhaul device (interference estimator), an AFC server, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 700 includes a processing device (e.g., a processor) 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)) and a data storage device 716, which communicate with each other via a bus 708.

Processing device 702 represents one or more general-purpose processing devices such as a microprocessor, central processing unit, or the like. More particularly, the processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also include one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computing device 700 may further include a network interface device 722 which may communicate with a network 718. The computing device 700 also may include a display device 710 (e.g., a liquid crystal display (LCD) or a cathode ray tube (CRT)), an alphanumeric input device 712 (e.g., a keyboard), a cursor control device 714 (e.g., a mouse) and a signal generation device 720 (e.g., a speaker). In at least one implementation, the display device 710, the alphanumeric input device 712, and the cursor control device 714 may be combined into a single component or device (e.g., an LCD touch screen).

The data storage device 716 may include a computer-readable storage medium 724 on which is stored one or more sets of instructions 726 embodying any one or more of the methods or functions described herein. The instructions 726 may also reside, completely or at least partially, within the main memory 704 and/or within the processing device 702 during execution thereof by the computing device 700, the main memory 704 and the processing device 702 also constituting computer-readable media. The instructions may further be transmitted or received over a network 718 via the network interface device 722.

While the computer-readable storage medium 726 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method for collecting frequency spectrum data for an automated frequency coordination (AFC) server, the method comprising:
determining, by one or more processors, an operation mode of a Wi-Fi access point;
in response to a determination that the operation mode is associated with 6 GHz transmissions, determining, by the one or more processors, a power mode of the Wi-Fi access point;
in response to a determination that the Wi-Fi access point is in a standard power mode, scanning one or more 6 GHz bands to begin collecting 6 GHz frequency spectrum data.

2. The method of claim 1, the method further comprising:
in response to a determination that the operation mode is unassociated with the 6 GHz transmissions, determining, by the one or more processors, that the Wi-Fi access point operates in one or more non-6 GHz bands.

3. The method of claim 1, the method further comprising:
in response to a determination that the Wi-Fi access point is in a non-standard power mode, determining, by the one or more processors, that the Wi-Fi access point is a low power mode or a very low power mode.

4. The method of claim 3, the method further comprising:
in response to a determination that the Wi-Fi access point is in the low power mode or the very low power mode, determining, by the one or more processors, not to start scanning the one or more 6 GHz bands.

5. The method of claim 1, wherein the one or more 6 GHz bands include one or more bands from unlicensed national information infrastructure (U-NII) bands.

6. The method of claim 1, the method further comprising:
in response to a determination that the Wi-Fi access point is in a non-standard power mode, the AP is moved to another frequency that is not being used.

7. The method of claim 1, the method further comprising:
stitching, by the one or more processors, the collected 6 GHz frequency spectrum data together.

8. The method of claim 7, the method further comprising:
transmitting, by the one or more processors, a report based on the stitched 6 GHz frequency spectrum data to an AFC server.

9. The method of claim 1, the method further comprising:
determining an interference caused by the access point on a 6 GHz communication channel, the determined interference to be used by the AFC server for interference reduction for future communications in the 6 GHz communication channel.

10. The method of claim 1, the method further comprising:
in response to a determination that the Wi-Fi access point is in the standard power mode, scanning 6 GHz Wi-Fi channels to begin collecting 6 GHz Wi-Fi frequency spectrum data.

11. The method of claim 10, the method further comprising:
decoding, by the one or more processors, one or more Wi-Fi packets that are associated with the collected 6 GHz Wi-Fi frequency spectrum data.

12. The method of claim 11, further comprising:
when the one or more Wi-Fi packets are decodable, generating a report of the 6 GHz Wi-Fi channels and transmitting the report to an AFC server; and
when the one or more Wi-Fi packets are un-decodable, transmitting the collected 6 GHz Wi-Fi frequency spectrum data to the AFC server.

13. A Wi-Fi access point for collecting frequency spectrum data for an automated frequency coordination (AFC) server, the Wi-Fi access point comprising:
data processing hardware; and
memory hardware in communication with the data processing hardware, the memory hardware storing instructions that when executed on the data processing hardware cause the data processing hardware to perform operations comprising:
determine an operation mode of a Wi-Fi access point;
in response to a determination that the operation mode is associated with 6 GHz transmissions, determine a power mode of the Wi-Fi access point;
in response to a determination that the Wi-Fi access point is in a standard power mode, scan one or more 6 GHz bands to begin collecting 6 GHz frequency spectrum data.

14. The Wi-Fi access point of claim 13, the operations further comprising:
in response to a determination that the operation mode is unassociated with the 6 GHz transmissions, determine that the Wi-Fi access point operates in one or more non-6 GHz bands.

15. The Wi-Fi access point of claim 13, the operations further comprising:
in response to a determination that the Wi-Fi access point is in a non-standard power mode, determine that the Wi-Fi access point is a low power mode or a very low power mode.

16. The Wi-Fi access point of claim 15, the operations further comprising:
in response to a determination that the Wi-Fi access point is in the low power mode or the very low power mode, determine not to start scanning the one or more 6 GHz bands.

17. The Wi-Fi access point of claim 13, wherein the one or more 6 GHz bands include one or more bands from unlicensed national information infrastructure (U-NII) bands.

18. The Wi-Fi access point of claim 17, wherein the U-NII bands include U-NII-5 band, U-NII-6 band, U-NII-7 band, and U-NII-8 band.

19. The Wi-Fi access point of claim 13, the operations further comprising:
stitching the collected 6 GHz frequency spectrum data together.

20. The Wi-Fi access point of claim 19, wherein stitching the collected 6 GHz frequency spectrum data together includes:
combining the collected 6 GHz frequency spectrum data associated with a same band.

21. The Wi-Fi access point of claim 19, the operations further comprising:
transmitting a report based on the stitched 6 GHz frequency spectrum data to an AFC server.

22. The Wi-Fi access point of claim 13, the operations further comprising:
in response to a determination that the Wi-Fi access point is in the standard power mode, scan 6 GHz Wi-Fi channels to begin collecting 6 GHz Wi-Fi frequency spectrum data.

23. The Wi-Fi access point of claim 22, the operations further comprising:
decoding one or more Wi-Fi packets that are associated with the collected 6 GHz Wi-Fi frequency spectrum data.

24. The Wi-Fi access point of claim 23, the operations further comprising:
when the one or more Wi-Fi packets are decodable, generate a report of the 6 GHz Wi-Fi channels and transmit the report to an AFC server; and
when the one or more Wi-Fi packets are un-decodable, transmit the collected 6 GHz Wi-Fi frequency spectrum data to the AFC server.

25. The Wi-Fi access point of claim 13, the operations further comprising:
determining an interference based on using a noise measurement on one or more pilot symbols.

26. The Wi-Fi access point of claim 25, wherein determining the interference based on using the noise measurement on the one or more pilot symbols includes performing a time analysis on one or more interferences locations.
